(19) United States
(12) Patent Application Publication
(10) Pub. No.: US 2002/0099726 A1
(43) Pub. Date: Jul. 25, 2002

(54) Method and system for distribution of file updates

(75) Inventors: Michele Crudele, Isernia (IS) (IT); Claudio Marineli, Aprillia (LT) (IT); Luigi Pichetti, Roma (IT)

Correspondence Address: Gerald R Woods, IBM Corporation T81/503, PO Box 12195, Research Triangle Park, NC, 27709, US

(73) Assignee: International Business Machines Corporation, Armonk, NY

(21) Appl. No.: 10/055,602

(22) Filed: Jan. 23, 2002

(30) Foreign Application Priority Data
Jan. 23, 2001 (EP) 01480007.2

(51) Int. Cl. G06F 12/00

(52) U.S. Cl. 707/200

(57) ABSTRACT

A method and system for distributing byte data files to endpoint stations through a network, the byte data files being modified versions of an base byte data file stored on the endpoint stations. The method comprises steps for creating a delta software package comprising at least one resulting delta file obtained by applying a differencing algorithm to the base byte data file and the modified byte data file. The method further comprises the step of adding in the header of the software package file, a data integrity code of the base byte data file. On the endpoint stations, the method comprises steps for comparing the base byte data file integrity of the code in the delta package to the code in the base byte data file stored on the end stations. If the code is identical, the delta file is used to rebuild the modified version of the base byte data file from the base byte data file stored on the end stations.

### FIELD OF THE INVENTION

The present invention generally relates to data distribution in a client-server environment and more particularly to the transfer of data update through a computer network.

### BACKGROUND OF THE INVENTION

In a client-server environment, IT resources are managed by a comprehensive solution including features such as network management as well as application management.

Application management on distributed sites implies code installation and update. To keep applications available, new versions of software need to be distributed through the network and installed on the target computers.

For instance, with the use of a software distribution system, customers can rapidly and efficiently deploy mission-critical or desktop productivity applications to multiple locations from a central point. With such software distribution systems, an administrator builds a software package to be distributed from the management server to the clients, more precisely, from the management server to the code subscribers on the endpoint stations. A software distribution system uses a protocol for software distribution. This protocol is implemented both in the management server, at specific nodes of the network and at endpoint stations.

The software packages files are built on the software manager server. They contain the new code to be installed and directives for installation understandable by the receiving endpoints.

The software package files are then sent from the administrator console connected to the software manager server through the network to the subscribers. A software distribution system may implement, in intermediate nodes, applications for efficiently routing software packages according to the list of subscribers. These intermediate nodes are called gateways.

The endpoint stations are able to receive the software package files sent through the network and to install the corresponding new version of the software. An application, often called a software distribution agent, operates on the endpoint stations for installation of the software and for applying the appropriate configuration changes to the system configuration.

The load of the network, in a distributed environment must always be minimized. Even if the technique of using gateways for routing software packages improves the use of bandwidth on the network lines, the size of the software packages remains critical. There is a need to minimize the use of bandwidth for the download of software package files sent from the management server to the endpoint stations.

Prior art solutions in this area concentrate on changes at the file level. In a known solution available from Microsoft Corporation, the current version to be sent is checked against the previous version. If a file has changed, its current version is transmitted. Otherwise, transmission is not required. It is also common to group the changed files with the installation commands and to compress them before sending the package over the network.

In U.S. Pat. No. 5,721,907, the approach for solving the problem is to identify the differences between the previous files and the new files. Only the differences are transferred to the endpoint stations. The source files are divided into blocks of the same size. Each block is assigned a computed key reflecting if there was a change or not in the corresponding block of data. The key computing is performed in both the receiving and the sending computer. A communication dialog is established between the sending and receiving computers, the result being that only blocks having a different computed key are sent from one computer to the other.

The principle of sending only the updates can be improved to fit with an existing framework for software distribution applied to a client-server environment. The solution of prior art rather applies to a communication between two computers connected through a communication line. As a matter of fact, it is not possible in a client-server environment to establish a protocol dialog between the sending and receiving computers as the sending is done between one software manager server and many endpoint stations.

There is a need for a solution which would support sending software packages including only code updates once and in a secure way.

### SUMMARY OF THE INVENTION

The invention is a method for distributing a data file, which is a modified form of a base data file, as a distribution package file in a data file distribution system comprising: a distribution server, where the distribution package file is created, in a network having nodes for routing the distribution package file to endpoint stations which are themselves adapted to install the distribution package file. The method includes the steps of creating, on the distribution server, a distribution package file, the delta distribution package file, comprising a delta file, created by applying a differencing algorithm to the base data file and the modified base data file and a data integrity code applied to the base file. Endpoint stations storing the base data file receive the delta distribution package file, compare the data integrity code with the data integrity code of the stored base data file and, if the code is identical, read the delta file and build a modified data file from the base data file and the delta file.

The step of creating the delta package may be a step of writing in the delta file at least one byte block itself comprising one directive for copying a sequence of bytes from the stored base data file and byte offsets identifying said sequence in said base data file. The rebuilding step further comprises a step of copying said sequence of bytes from stored base file to the rebuilt modified data file using the byte offsets, when the directive for copying is read in the delta file,.

The step of creating the delta package further may include a step of writing in the delta file at least one byte block comprising a directive for adding a new sequence of bytes and the new sequence of bytes, while the rebuilding step further comprises a step of copying, when a directive for adding is read in the delta file, said new sequence of bytes to the rebuilt modified data file.

One major advantage of the current solution is that it applies at a byte level, this means that the method is applicable not only to the distribution of applications but also to the distribution of data files. For instance, this method can apply to the distribution of price lists which need to be periodically updated on thousand of workstations. With the method of the present invention, one can generate a “delta file” that contains only “changed prices” between the previous list and the current one. This method is not dependent on the format of the data files to be compared and updated.

### BRIEF DESCRIPTION OF THE DRAWINGS

FIG. 1 is an illustration of the software distribution system wherein the solution of the present invention may be implemented;

FIG. 2 illustrates the content of the code update file obtained by the method according to the present invention;

FIG. 3 is an example of the optional “depot table” which keeps track of the software packages which are stored in a depot close to the endpoint station.

FIG. 4 shows the flow chart of the method for building the software package on the software manager server according to the present invention;

FIG. 5 shows the flow chart of the method for receiving and installing the software package on the endpoint stations according to the present invention.

### DESCRIPTION OF THE PREFERRED EMBODIMENT

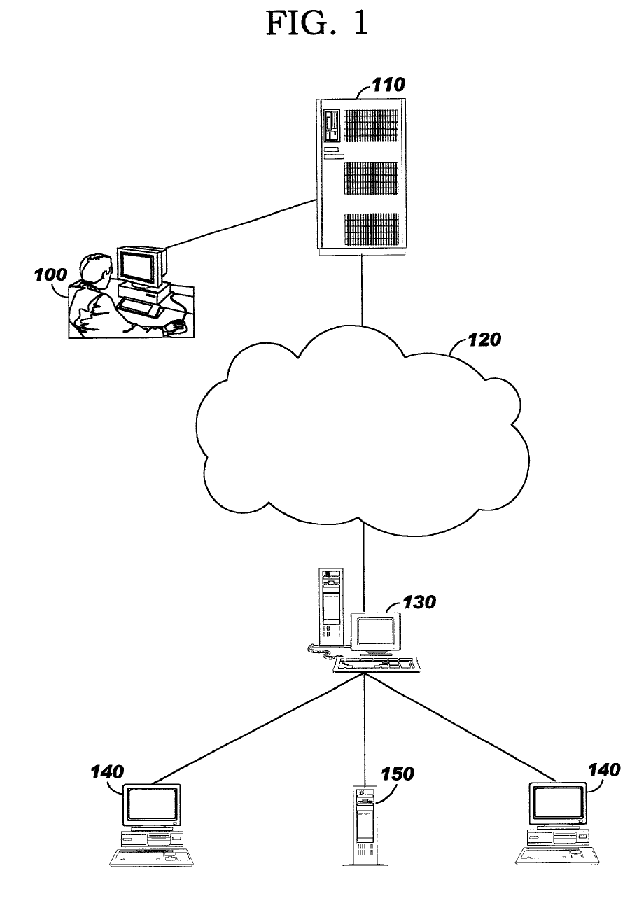

FIG. 1 shows the software distribution process in a client-server environment. The administrator (100) accesses the software manager server (110) to prepare the software packages, send them through the network and ask for their installation in the system libraries of the endpoint stations corresponding to a list of subscribers. A software package is a file containing the new code to be installed and directives for new code installation to be executed on the endpoint stations. The new code may comprise one or more than one file. The administrator creates software package files on the software manager server. The administrator uses the user interface, preferably a graphic user interface, with the software distribution application operating on the software manager server. The distribution of software package is activated by a command from the software manager server (110). The server sends the software package files to the designated target endpoint stations through the network (120). In a preferred form of software distribution system, gateways are used as intermediate routing points for the software distribution. In FIG. 1, the gateway (130) is able to identify that the software distribution package file to be sent to a list of subscribers must be distributed to three endpoint stations (140, 150). The software package file is routed by the gateway to the target endpoints which are either personal computers (140) or other servers (150). Once received in the target endpoints, the software package is read and launched by an application, a software distribution agent, for code installation and execution of system library update.

As described in FIG. 1, the software is distributed by one command from the server to the designated endpoint stations. The launching of the code update may be started at different times according to the sophistication of the management agent application. With the use of the preferred embodiment as implemented in the server (110) and in the endpoints (140, 150) the distribution is done only once but the size of the code is dramatically reduced as it only conveys a delta software package file only comprising code updates.

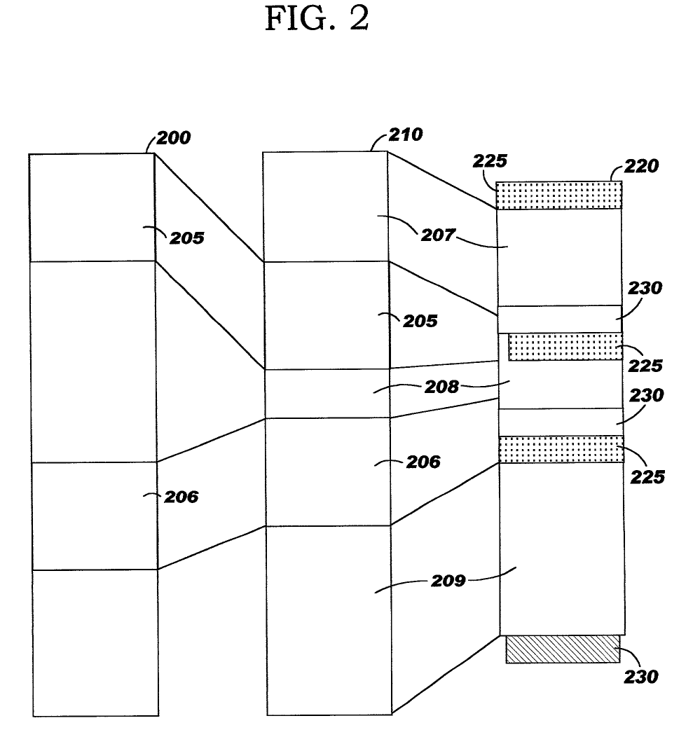

FIG. 2 illustrates the resulting code update file comprising the encoded software update according to the method of the preferred embodiment. The base file (200) is the previous version of the code to be updated. The version file (210) is the new version of the code which needs to be installed and run on the endpoint stations. The delta file (220) is the real file which will be sent, result of the method of the preferred embodiment. The delta file is a succession of blocks which can be of two types: blocks comprising “matching sequences” of code and blocks comprising new sequences of code. Matching sequences of bytes are identified (205, 206) by comparing the version file and the base. Matching sequences are code sequences that exist in both the previous and the new version of the code. Matching sequences of code are not be copied into the delta file according to the preferred embodiment. Only new data (207, 208 and 209) will become part of the resulting delta file. Each block in the delta file includes directives (225, 230) directly executable by the endpoint stations. The two directives used (225, 230) in the delta file are the “add” command (225) preceding the code portions which are new and the “copy” command (230) preceding the code portions to be copied from the previous version of the code to be updated (205, 206). The “copy” command has parameters providing the offset of the field to be copied in the version file. The delta file can be read on the endpoint stations which will be able to rebuild the new version to be installed.

A software distribution process can be accomplished in three phases. The first phase is preparing the software package including a set of new code to be distributed and installed on endpoint stations. The delta file for each new code file is prepared. The software package file comprises the delta files and in its header, a data integrity code, such as a crc32 cyclical redundancy check character for the base file. This data integrity code, computed at the creation of the software package, is used by the endpoint station to check the validity of the base files before starting installation of the new code with the delta files. This software package is built by the administrator from a console connected to the software manager server. The administrator starts an application operating on the software manager server using the graphic user interface for entering commands. The first phase is started with the “Build SP” command. This command starts the building of the software package file. Parameters such as the name and version of the software package (SP_LABEL, SP_VER) are provided to the application by the administrator during the first phase.

The optional depot process of a software distribution system is most often used when software is frequently updated. The software package is installed on a depot close to the endpoint station. A depot is a gateway configured in such a way to cache software packages so that they don't need to be re-transmitted from the server every time they are distributed, saving network bandwidth.

The installation is performed on the endpoint station using the software distribution package installed on a nearby station: this process helps in offloading the endpoint station from storing the software packages. If the optional depot process is used, the name of the software distribution (DEPOT_LABEL for a depot) is seized as a parameter of the Build SP command. With the optional depot process, software distribution operations are tracked on the software manager server.

The second phase of the software distribution process consists of sending the software package to a set of endpoint stations, which can be either personal computers or servers, on which the new version of the code needs to be installed. The send command is initiated through the administrator application. The send may be executed either immediately or may be delayed. The software package can be sent through the network either directly to a endpoint station or to the software distribution gateways as described in FIG. 1 which themselves route the software distribution package to the endpoint stations. When the download is executed, a download timestamp is stored by the application on the software manager server. If the software depot option is chosen, the software packages are sent to a gateway close to the endpoint station for a further process of new code installation from this close station.

The third phase of the software distribution process is executed on the endpoint stations which preferably include a software distribution agent able to receive the software package, read it and launch the installation process. These operations are performed sequentially on the endpoint stations. Optionally, these operations can be separately executed. Even if it is possible to delay all the intermediate operations, the process of sending software and installing it on the endpoint stations is usually started from the administrator console when the command “SD INSTALL” is entered.

The software distribution method of the preferred embodiment is implemented in these three phases of the software distribution process. With the method of the preferred embodiment in the first phase, the administrator application allows either a “Build SP” or a “Build delta SP”. Two additional parameters are given to the application by the administrator in the preferred embodiment. They are the type of software distribution (TYPE) and the name and version of the previous code to be updated (BASE_SP_NAME, BASE_SP_VER).

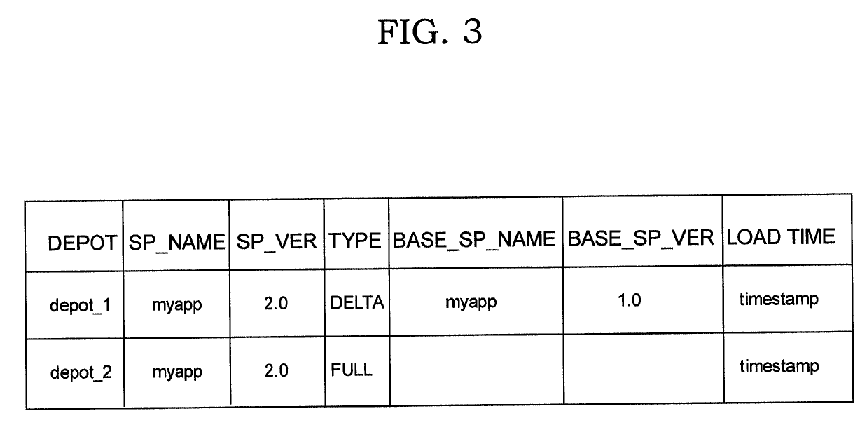

FIG. 3 shows an example of a new “depot table” built during the first phase of the method of the preferred embodiment when the software depot option is chosen by the administrator. This table is used to keep track of the different software updated operations when they occur frequently. The table, stored on the software manager server, is populated by the application which builds the software package on the software manager server. The table stores the parameters entered by the administrator which are used for the software distribution and the time of downloading of the software package. In FIG. 3, the first row describes the depot_{—}1 “depot” which is the software package for installing the application myapp version 2.0 as a delta software package using as a base file the application myapp version 1.0, timestamp being the time of the downloading of the delta software package. The second row records a second creation of software package which corresponds to the depot depot_{—}2, of myapp version 2.0. This second row is for a full software package for this application and version downloaded at the timestamp as stored.

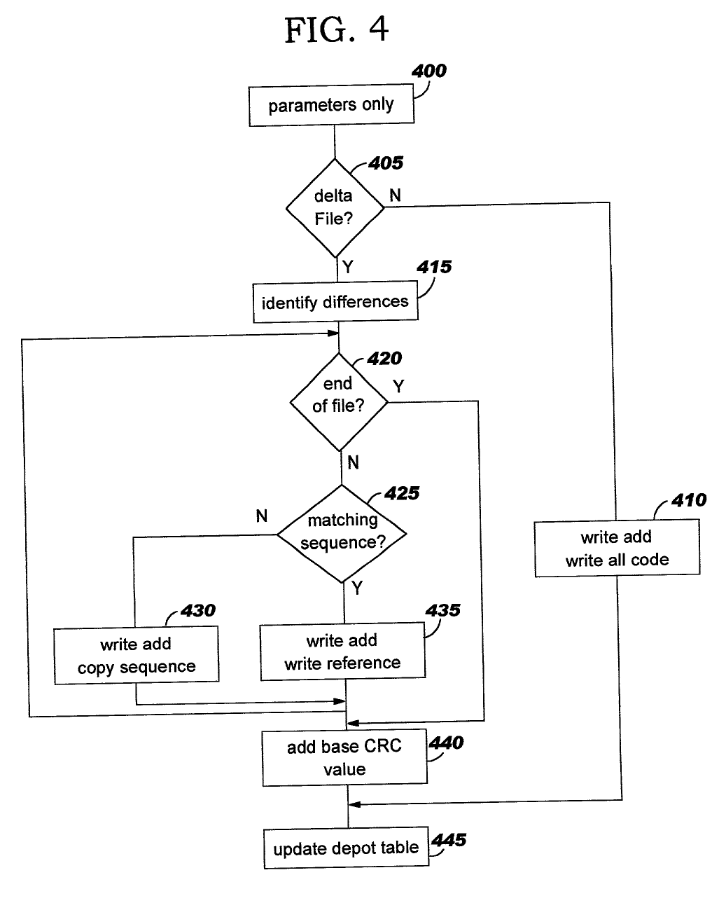

FIG. 4 shows the flow chart of the steps of the method of the preferred embodiment for building the software package. In the preferred embodiment an application is executing on the software manager server to which the administrator console is connected. Through a graphic user interface the administrator can order the building of a software package and provides parameters. If the depot option is chosen, the operations on the software packages are all recorded. This can be very useful for applications that are frequently updated and distributed to the endpoint stations. The endpoint stations receiving the application code updates are the “subscribers”. The parameters entered by the administrator are the name and version of the application code to be sent, the list of names of the subscribers. The software package comprises both code and commands to be executed on the endpoint station which allow launching the code installation. These commands are machine type dependent and thus the final software package file which will be downloaded will be machine type dependent. The type of software package to be built will be defined by the application according to the subscriber name entered by the administrator. Once the parameters are entered (400), the application asks the administrator if he wants to build a delta software package (405). If the answer to the test (405) is no, the application builds a software package (410) comprising all the new code that is without reducing the size of the software package file. The software package comprises also a directive to install all the following code which is the “add” command understandable by the endpoint station. If the answer to the test (405) is yes, a delta software package file is to be built. A differencing algorithm is then applied to the files containing the previous version of the code and the new code. The differencing algorithm, known from the prior art, finds and outputs the differences between a file and a modified version of the same file. In output, the differencing algorithm provides a delta file as described above in FIG. 2. The delta file is a sequence of directives add and copy. The add directive contains new data that must be added to the base file at a certain offset to rebuild the version file; the copy directive only indicates what data bytes are to be copied to the version file to rebuild it. The delta file is a compressed version of the version file with the constraint that it needs the base file to rebuild the version file. Coming back to FIG. 4, using a differencing algorithm, the identification of differences in the code is started (415). If the end of file is not reached (answer no to test 420), and if one matching sequence is identified between the base code and the new version (answer yes to test 425), a “add” directive is written (435) into the delta file output of the differencing algorithm. The add directive identifies the offsets where code is to be copied from the base file to rebuild the new version of the code from the delta file and the base code. If no matching sequence is identified between the base code and the new version (answer no to test 425), the part of new code coming from the new version is copied to the delta file with the “add and copy” directive (430) for adding the new code copied for rebuilding the new version from the delta file. If the end of file is reached (answer yes to test 420) the CRC32 of the base file is added (440) to the header of the software package file. This CRC32 or any data integrity checking code is used to insure, at the endpoint station, the use of the correct base file to start rebuilding the new version starting from the base file supposed being already installed in the endpoint station. As the CRC32 is located in the header of the software package, the checking of data integrity is performed before reading the code update. If the base file located on the endpoint station has the same CRC32 as the code written in the header of the software package, the installation process continues. If not, the operation is abandoned. There are as many CRC32 in the header of the software package as the number of base files to be used in the installation of the new code.

If the depot option is used, the depot table keeping track of the created and downloaded code updates is updated (445) with the inputs of the administrator as described in the first row of the table of FIG. 3. This step of the method is not mandatory. If the choice of the administrator is to download the entire new version of the code without using the advantage of the delta file, (answer no to test 405) the software package file is built with directives for adding the entire new code which is copied after the add and copy directive (410). If the depot option is used, the depot table is then updated as described in the second row of the table of FIG. 3.

The method comprises two steps for downloading a software package file built according to the previous steps of the method. The first step consists in sending the software package file to the “subscribers” as listed in the parameters provided by the administrator. The software package will be adapted to the system operating on the endpoint station of the subscriber. The telecommunication protocol is network dependent. The software package to be sent can be sent to a gateway acting as intermediate software distribution node according to the software distribution architecture employed in the preferred embodiment. The second step after sending is, if the depot option is used, the update of the depot table with the downloading timestamp written in the last field of the table row as described with FIG. 3.

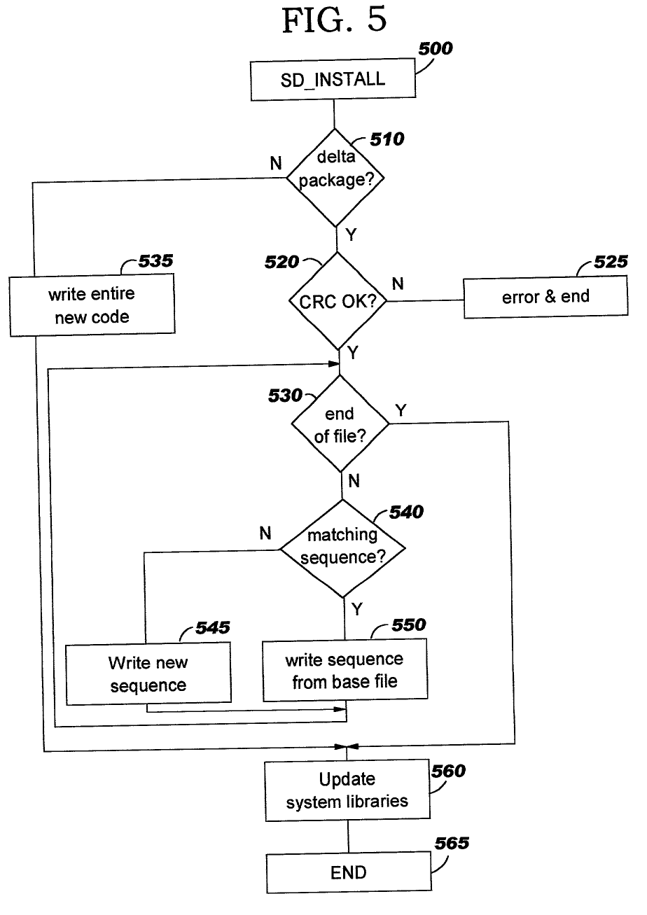

The flow chart of FIG. 5 shows the steps of the method of the preferred embodiment for installing a new version of a code on an endpoint station. If the depot option is used, the software package is stored on a gateway close to the endpoint station. If the depot option is not used, the software package is sent directly from the software manager server to the endpoint station through the network. A software distribution package installation may be started from the administrator console or from the endpoint station itself. With the corresponding command “SD_INSTALL”, is provided, as attribute, the name of the software package which can be either a “full” software package containing the entire new code to be installed or a “delta” software package containing a delta file. The installation of a “delta” software package consists in rebuilding the new version of the code from the base file (the previous version of the code) already installed on the endpoint station. When a “SD_INSTALL” command is started (500), if a delta software package is to be installed (answer yes to test 510), the CRC's in the header of the software package is extracted and checked against the CRC's for the base files of the previous level of the code which is already stored on the endpoint station. If the compared CRC's don't match (answer no to test 520), the SD_INSTALL operation is stopped with an error message (525) saying that either the base file or the corresponding new code files are not correct and that the new version of the code cannot be rebuilt from the base files stored on the endpoint station. If the CRC check is satisfactory (answer yes to test 520), the reconstruction process is launched and an output file containing the rebuilt new version of the code is prepared for each delta file received. The delta files are sequentially read. When a add directive is encountered, there is a matching sequence (answer yes to test 540), of bytes identified in the delta file by the offsets in the base file. This matching sequence is extracted from the base file and copied (550) to the output file. When an add copy directive is encountered, there is a sequence of bytes which is new vis a vis the previous version of the code and the following bytes in the delta file are copied (545) to the output file. This sequence of steps is repeated until the end of delta file is reached (answer No to test 520) for each of the delta files contained in the software package.

If the SD_INSTALL command specifies the installation of a “full” software package (answer no to test 510), the entire code stored in the software package files is copied on the endpoint station (535).

Once the new version is installed after copying the entire code stored in the “full” software package or when the end of delta file has been reached (answer yes to test 530) for a “delta” software package, the system libraries are updated with the references to the new version of the code (560) and the operation ends (565).

More commonly, the installation operation is implemented as a program operating on the endpoint station. It is activated as a command from one other program operating on the same endpoint station or from one other program operating on the software manager server. This later program is part of the application operating on the software manager server accessed via a graphic user interface, in the preferred embodiment, from the administrator console.

It is noted that the method of the preferred embodiment requires computing resources on the software manager server to build the delta software package and on the endpoint stations to rebuild the new version of the code from the delta software package. More particularly, an appropriate differencing algorithm should be used to minimize memory requirement and CPU time, such as the algorithm recommended in the thesis “Differential completion: A Generalized Solution for Binary Files” in completion of the Master's of Science degree, Department of Computer Science, University of Calif., Santa Cruz, December 1997. For small files one may use the an HPCP algorithm while for bigger files (greater than 10 Mb), it may be more appropriate to use a One Pass algorithm. Both algorithms are both described in the referenced thesis.

The same method as described may be applied to the distribution of an updated version of any existing byte data file because it applies at the byte level. The method applied to data file distribution provides the same advantage of line bandwidth saving in the network used for distribution.

CRC32 or any type of CRC or any known code used for data integrity checking can be used in the method of the present invention for data integrity checking of the base file and for the security of the rebuilding operation of the new data file in the endpoint stations.

1. A method for updating base files previously stored on endpoint stations, said method comprising the steps of:
generating a data integrity code based on the contents of the base file to be updated;
generating a delta file by applying a differencing algorithm to the base file to be updated and to a modified form of the base file; and
creating a delta distribution package including the generated data integrity code and the generated delta file.

2. A method as recited in claim 1 wherein the step of generating a delta file further includes the step of writing one or more blocks into the delta file, each of said blocks comprising byte offsets identifying the location of code sequence in the base file and a directive to copy the identified code sequence into a modified form of the base file.

3. A method as recited in claim 2 wherein the step of generating a delta file further includes the steps of writing one or more new byte sequences into the delta file along with one or more directives defining where such new byte sequences are to be written into the modified form of the base file.

4. A method as recited in claim 3 including the additional step of distributing the delta distribution package to one or more endpoint stations on which the base file is already installed.

5. A method as recited in claim 4 further including the steps of:
receiving the delta distribution package in at least one endpoint station in which the base file is already installed;
comparing the data integrity code received in the delta distribution package to a data integrity code associated with the base file already installed in the endpoint station;
if the data integrity codes match, updating the installed base file by retrieving the directives and code sequences from the delta distribution package and executing the directives to rebuild the installed base file into a modified form of that file.

6. A method for updating a base file previously installed at an endpoint system comprising the steps of:
receiving a delta distribution package containing at least one data integrity code, one or more byte offsets identifying the location of code sequences in the previously installed base file, one or more new code sequences and one or more directives for utilizing either the new code sequences or code sequences in the base file that are identified by the byte offsets;
comparing a data integrity code received in the delta distribution package to a data integrity code already stored in the endpoint station; and
if the compared codes match, executing the directives received in the delta distribution package to write new code sequences received in the delta distribution package and existing code sequences identified in the base file into a modified form of the base file.

7. A system for updating base files previously stored on endpoint stations, said system comprising:
a code check character generating for generating a data integrity code based on the contents of a base file to be updated;
a delta file generating for applying applying a differencing algorithm to the base file to be updated and to a modified form of the base file to product a delta file; and
a delta distribution package generating for creating an update package including the generated data integrity code and the generated delta file.

8. A system as recited in claim 7 wherein the delta file generator further code writing means for writing one or more blocks into the delta file, each of said blocks comprising byte offsets identifying the location of code sequence in the base file and a directive to copy the identified code sequence into a modified form of the base file.

9. A system as recited in claim 8 wherein the delta file generating further includes code writing means for writing one or more new byte sequences into the delta file along with one or more directives defining where such new byte sequences are to be written into the modified form of the base file.

10. A system for updating a base file previously installed at an endpoint station comprising:
a receiver for a delta distribution package containing at least one data integrity code, one or more byte offsets identifying the location of code sequences in the previously installed base file, one or more new code sequences and one or more directives for utilizing either the new code sequences or code sequences in the base file that are identified by the byte offsets;
comparison logic for comparing the data integrity code received in the delta distribution package to a data integrity code associated with the base file already installed in the endpoint station;
update logic responsive to a match between the compared data integrity codes to retrieve the directives and code sequences from the delta distribution package and to execute the directives to rebuild the installed base file into a modified form of that file.
